(19) United States
(12) Patent Application Publication
(10) Pub. No.: US 2006/0144057 A1
(43) Pub. Date: Jul. 6, 2006

(54) Key performance index calculation and real-time condition monitoring methods for heat exchanger

(75) Inventors: Huei-Shyang You, Taoyuan County (TW); Wen-Yao Chang, Taipei County (TW); Chih-Wei Lai, Hsinchu City (TW); Tzxy-Chyi Wang, Taipei County (TW)

Correspondence Address: QUINTERO LAW OFFICE, 1617 BROADWAY, 3RD FLOOR, SANTA MONICA, CA, 90404, US

(73) Assignee: INDUSTRIAL TECHNOLOGY RESEARCH INSTITUTE, HSINCHU (TW)

(21) Appl. No.: 11/322,030

(22) Filed: Dec. 28, 2005

(30) Foreign Application Priority Data
Dec. 30, 2004 (TW) TW93141357

(51) Int. Cl. F25B 49/00; G01K 13/00; G05D 23/32

(52) U.S. Cl. 62/126; 62/157; 62/129

(57) ABSTRACT

A method for calculating key performance indexes. The method comprising defining running indexes for a heat exchanger of a chiller, obtaining an outlet temperature of output matter of the heat exchanger according to the running indexes, at least comprising load temperature, load current, inlet temperature of cooling matter, outlet temperature of the cooling matter, and inlet temperature of the output matter, obtaining a performance index according to the inlet and outlet temperatures of the output matter and the load current of the heat exchanger, obtaining a predicted performance index according to the inlet temperature of the output matter, a predicted outlet temperature of the output matter, and the load current, obtaining a real performance index according to the inlet temperature of the output matter, real outlet temperature of output matter, and the load current, and obtaining a key performance index according to the predicted and real performance indexes.

### BACKGROUND OF THE INVENTION

1. Field of the Invention

The present invention relates to real-time condition monitoring methods, and in particular relates to real-time condition monitoring for a running heat exchanger of a chiller based on key performance indexes.

2. Description of the Related Art

Equipment condition monitoring (ECM) governs running conditions of equipment and reduces the probability of unexpected failure by predictive maintenance mechanisms, raising effective running efficiency and reducing maintenance cost. In semiconductor manufacturing, optoelectronic manufacturing, integrated circuit manufacturing, or liquid crystal display manufacturing, ECM seriously affects production capacity and efficiency, in which a heat exchanger of a chiller serves as an important monitoring index.

With respect to conventional heat exchangers of chillers, control limits for measurements (such as temperature, pressure, current load, and the like) of equipment or coefficient of performance (COP) are generated according to experience or specifications defined by vendors. Additionally, real-time condition monitoring is implemented using statistical process control (SPC) strategies according to equipment measurements and COPs. The control models are not generated according to such SPC strategies, and multivariate and complicated statuses relating to chillers or running performance determination is difficult to manage by predicting running statuses of diagnostic equipment based on data experience models created according to the SPC strategies.

Drawbacks of current monitoring method comprise the inability to accurately detect delayed variation and abnormality of equipment performance, non-consideration of load conditions or control variation for equipment resulting in high incidence of “type I false alarms”, and non-utilized historical data leading to creation of control models incapable of precisely regulating equipment health status.

Thus, an improved monitoring method using key performance indexes is desirable.

### BRIEF SUMMARY OF INVENTION

A method for calculating key performance indexes relating to a heat exchanger of a chiller is provided. In an embodiment of such a method, running indexes for the heat exchanger of the chiller are defined. An outlet temperature of output matter of the heat exchanger is obtained according to the running indexes, comprising at least load temperatures, load current, inlet temperatures of cooling matter, outlet temperatures of cooling matter, and inlet temperatures of the output matter. A performance index is obtained according to the inlet and outlet temperatures of the output matter and load current of the heat exchanger. A predicted performance index is obtained according to inlet temperatures of the output matter, predicted outlet temperatures of output matter, and the load current. A real performance index is obtained according to the inlet temperatures of the output matter, real outlet temperatures of output matter, and the load current. A key performance index is obtained according to the predicted and real performance indexes.

Also disclosed is a real-time condition monitoring method for a heat exchanger of a chiller. In an embodiment of such a method, historical running data relating to a heat exchanger of a chiller is retrieved. An outlet temperature prediction model for output matter of the heat exchanger is created according to the historical running data. An outlet temperature of the output matter of the heat exchanger is predicted using the outlet temperature prediction model and a predicted performance index is obtained according to the outlet temperature. Real-time running data relating to the heat exchanger is retrieved, a real performance index relating to the heat exchanger is obtained according to the real-time running data, and a key performance index relating to the heat exchanger is obtained according to the predicted and real performance indexes. The heat exchanger is monitored according to the key performance index using statistical methods. Running conditions relating to the heat exchanger are determined according to monitor results.

### BRIEF DESCRIPTION OF DRAWINGS

The present invention can be more fully understood by reading the subsequent detailed description and examples with references made to the accompanying drawings, wherein:

FIG. 1 is a schematic view of a heat exchanger of a chiller;

FIG. 2 is a flowchart of an embodiment of the method for calculating key performance indexes;

FIG. 3 is a flowchart of an embodiment of creating an outlet temperature prediction model;

FIG. 4 is a flowchart of an embodiment of the real-time condition monitoring method for a heat exchanger of a chiller;

FIG. 5 is a schematic view of conventional EWMA control charts for modified COP indexes;

FIG. 6 is a schematic view of autocorrelation feature analysis for conventional COP values;

FIG. 7 is a schematic view of conventional EWMA control charts for outlet temperatures relating to a heat exchanger of a chiller;

FIG. 8 is a schematic view of conventional EWMA control charts for load current relating to a heat exchanger of a chiller;

FIG. 9 is a schematic view of EWMA control charts for SPC strategies based on residue-based monitoring; and

FIG. 10 is a schematic view of autocorrelation feature analysis for residue-based monitoring indexes.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

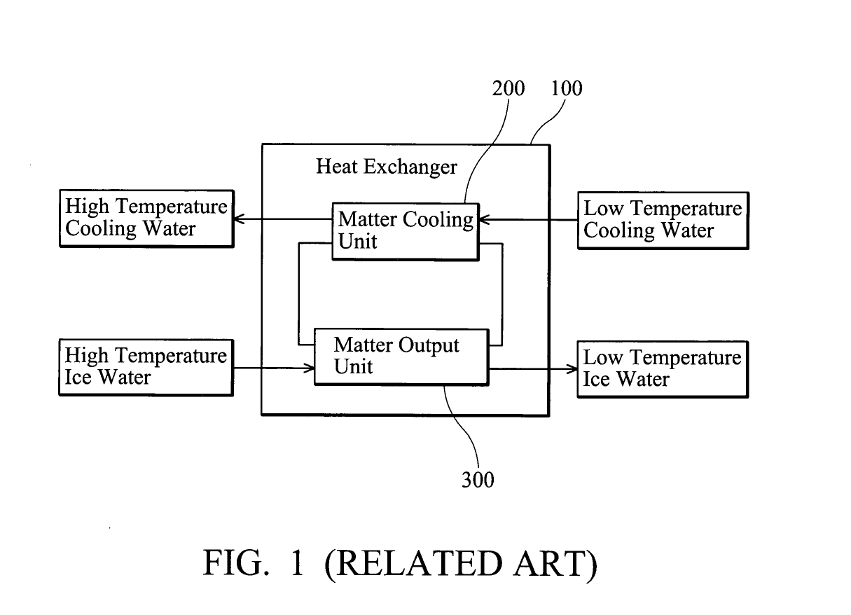

FIG. 1 is a schematic view of a heat exchanger of a chiller. Heat exchanger 100 of a chiller comprises a matter cooling unit 200 and a matter outputting unit 300. Equipment sequentially generates output matter applied to processes and manufactories by heat exchange between matter cooling unit 200 and matter outputting unit 300. Generally, output matter acts as chilled water while cooling matter acts as cooling water or refrigerant.

To utilize the described heat exchanger to improve equipment monitoring, the invention discloses a method for key performance index (KPI) calculation and real-time condition monitoring.

An embodiment of the invention utilizes a statistics regression model (partial least squares (PLS), for example) to create mathematical models for estimating outlet temperatures of output matter to solve problems of variation and the average of COPs derived from an heat exchanger changing due to the variation of load conditions of a chiller and the external environment (such as the change of inlet temperatures of refrigerant or environmental temperatures). Further, the invention discloses a new model to predict residual KPI monitoring indexes and utilizes residue-based monitoring SPC strategies to reduce the number of type I alarms caused by load conditions of a chiller, inlet temperatures of output matter, inlet and outlet temperatures of cooling matter, or variation control to a sensible level, achieving real-time and efficient equipment condition monitoring.

COP defined by thermodynamics is the ratio of cooling efficiency to input energy from a chiller, utilizing removable thermal capacity in per unit energy of per unit time to act as a performance reference index. As described, calculating results of COP changes due to the variation of load conditions of a chiller and the external environment (such as the change of inlet temperatures of refrigerant or environmental temperatures), such that false alarms are also detected due to the variation of load conditions of a chiller or the external environment even equipment running conditions are acceptable. Variables, comprising inlet temperatures of output matter from a chiller, outlet temperatures of output matter from a chiller, load current from a chiller, and the like, which are probable influences on COP calculation are obtained according to obtained running data of a chiller using variance analysis methods, determining whether outlet temperatures are classified into different groups according to different settings of outlet temperatures from a chiller.

With respect to real-time running conditions, different external environmental settings may result in different outlet temperatures from a chiller, comprising outlet temperatures of output matter classified into different groups, 50% of outlet temperatures of output matter are classified into different groups, and 80% to real load currents are classified into different groups. Thus, if the described equipment data and COP are determined as monitor indexes, different group distributions of monitoring indexes are generated due to the variation of load conditions of a chiller and the external environment, such that a control strategy with fixed measurement is difficult to apply to equipment condition monitoring.

Accordingly, the invention predicts residual KPI monitoring indexes and solves the problem of COP changes following the change of load settings of a chiller and variation of the external environment. In practice, while a chiller is running normally, based on invariable constant pressure specific heat, matter flow, and load voltage of output matter of a chiller, COP can be modified as a new index, the ratio of the outlet and inlet temperatures of output matter to load current of a chiller, and residue of the index can be applied to be a monitor index (a key performance index disclosed in the invention) for equipment conditions.

Additionally, while a chiller is running normally, key performance indexes defined according to outlet temperatures of output matter are analyzed using a method for analysis of variance to determine if 80% of the indexes can be grouped. Such analysis results show that the monitor indexes change due to the variation in load conditions of a chiller and the external environment, which is not suitable for a control strategy with fixed measurement applied to equipment condition monitoring. A KPI calculation process is described as following.

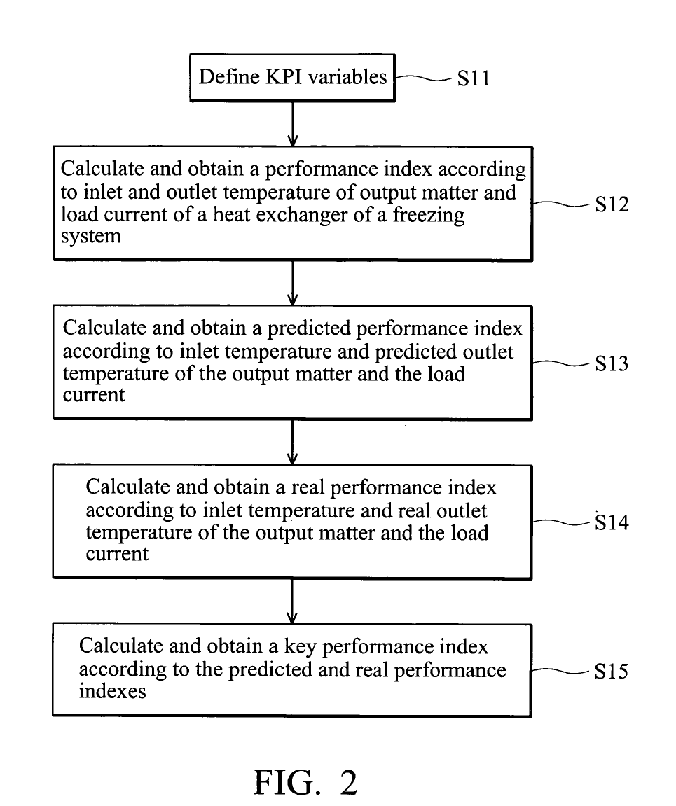

FIG. 2 is a flowchart of an embodiment of the method for calculating key performance indexes, determining the residue of the subtraction of an actual value and a predicted value for a new performance index as an equipment condition monitoring index (a KPI herein) to judge physical conditions of a chiller. Useful parameters for KPI calculation are first defined (step S11), as shown in Table 1.

TABLE 1

| | |
|---|---|
| A | load current of a chiller |
| Cₚ | constant pressure specific heat of output matter of a chiller |
| COP | coefficients of performance defined by thermodynamics |
| Index_{new} | new performance index |
| Index_{new}^{act} | new performance index by actually measured |
| Index_{new}^{pre} | new performance index by prediction based on key indexes |
| KPI | key performance index for equipment condition monitoring |
| m_{chw} | matter flow of output matter of a chiller |
| T_{chw}ⁱⁿ | inlet temperature of output matter of a chiller |
| T_{chw}^{out} | outlet temperature of output matter of a chiller |
| T_{chw}^{out}^{act} | outlet temperature of actual output matter of a chiller |
| T_{chw}^{out}^{pre} | predicted value for outlet temperature of output matter |
| | of a chiller |
| T_{cw}ⁱⁿ | inlet temperature of cooling matter of a chiller |
| T_{cw}^{out} | outlet temperature of cooling matter of a chiller |
| Tₛₚ | load setting temperature of a chiller |
| V | load voltage of a chiller |

As described, COP defined by thermodynamics is the ratio of cooling efficiency to input energy from a chiller, utilizing removable thermal capacity in per unit energy of per unit time to act as a performance reference index.

Since constant pressure specific heat, matter flow, and load voltage of output matter of a chiller are generally fixed, the COP can be modified as a new index, the ratio of the outlet and inlet temperatures of output matter to load current of a chiller, as calculated by formula (1) shown in Table 2 (step S12). In other words, step S12 is to obtain a performance index according to outlet and inlet temperatures of output matter of a device and load current thereof. The performance index equals the ratio of the outlet and inlet temperatures of output matter to load current. The relation between the outlet and inlet temperatures of output matter and a key performance index can be represented by formula (2) shown in Table 2. Accordingly, the outlet temperature of output matter of the device is calculated according to a plurality of device indexes, comprising load setting temperature, load current, inlet temperature of cooling matter, outlet temperature of cooling matter, and the inlet temperature of output matter.

Next, as shown by formula (2), an outlet temperature predicted value of the output matter of the normally operated chiller is predicted using an outlet temperature prediction model provided by the output matter of the chiller for necessary cyclic error adjustment to obtain a predicted performance index of the normally operated chiller (step S13), as calculated by formula (3) shown in Table 2. In other words, step S13 is preformed to obtain a performance index according to the inlet and outlet temperatures of the output matter and the load current of the device. Next, a real performance value is obtained according to real running data (step S14), as calculated by formula (4) shown in Table 2. In other words, step S114 is preformed to obtain a real performance index according to the inlet temperature of the output matter, real outlet temperature of output matter, and the load current. A key performance index is obtained using the residue of the performance predicted value (the value calculated by formula (3)) calculated using measurement values and model prediction (step S15), as calculated by formula (5) shown in Table 2. In other words, step S15 is preformed to obtain a key performance index according to the predicted and real performance indexes.

TABLE 2

| | |
|---|---|
| ${Index}_{new} = COP \frac{V}{{m}_{chw} \times {C}_{p}} = \frac{{T}_{chw}^{in} - {T}_{chw}^{out}}{A}$ | (1) |
| ${T}_{chw}^{out} = f ( {T}_{sp} , A , {T}_{cw}^{in} , {T}_{cw}^{out} , {T}_{chw}^{in} )$ | (2) |
| ${Index}_{new}^{pre} = ( {T}_{chw}^{in} - {T}_{chw}^{{out}^{pre}} ) / A$ | (3) |
| ${Index}_{new}^{act} = ( {T}_{chw}^{in} - {T}_{chw}^{{out}^{act}} ) / A$ | (4) |
| ${Index}_{new}^{act} - {Index}_{new}^{pre} = KPI$ | (5) |

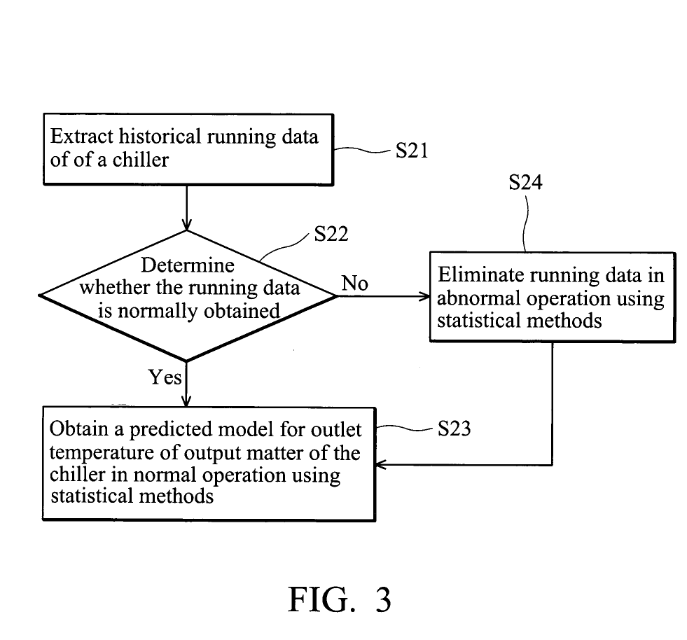

Additionally, the outlet temperature prediction model with respect to the matter of the chiller is constructed as follows. FIG. 3 is a flowchart of an embodiment of creating an outlet temperature prediction model.

Historical running data relating to a chiller is retrieved (step S21). It is determined whether the historical running data is retrieved while the heat exchanger is running normally (step S22). If so, the outlet temperature prediction model with respect to the output matter of the normally running chiller is created using statistical methods (step S23). If not, the historical running data retrieved abnormally is removed (step S24).

A process of a real-time condition monitoring for a chiller is described.

Since running data of a chiller and COP may change following the change of load conditions of a chiller and the external environment and comprise apparent cyclic autocorrelation features, sensible control limits thereof must change following variations of setting conditions of chiller load and the external environment and must display uniform cyclic variation. Such a situation cannot be monitored using a control limit with fixed measurement. Thus, monitoring the health condition of a chiller must be implemented using a valid control strategy, eliminating the cyclic autocorrelation features of indexes, preventing monitor indexes from changing following variations of setting conditions of chiller load and the external environment, eliminating or reducing the number of type I false alarms corresponding to SPC strategies, and utilizing fixed control limits for operative health condition monitoring.

Thus, residual key performance indexes for monitoring of the invention do not change following variations of setting conditions for chiller load and the external environment and comprise cyclic autocorrelation features, such that control limits with fixed measurement can be applied to monitoring.

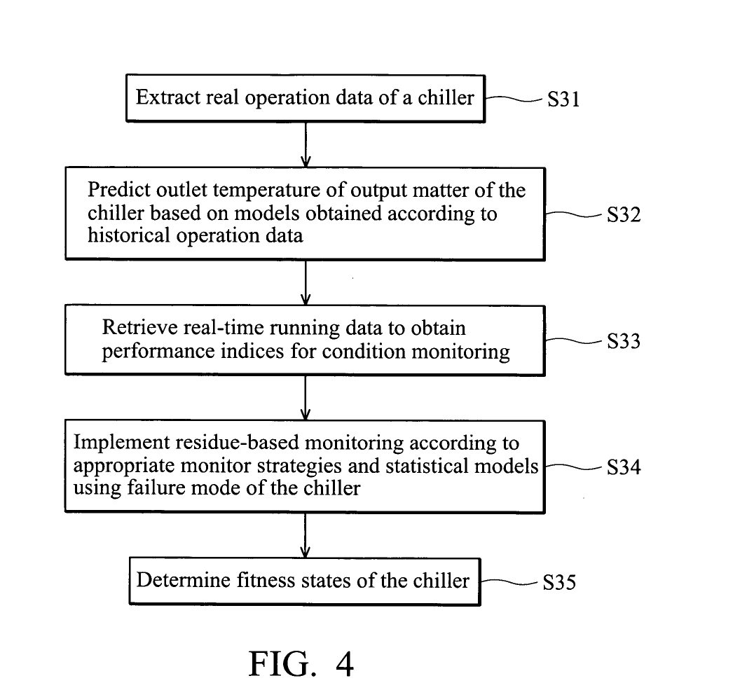

FIG. 4 is a flowchart of an embodiment of the real-time condition monitoring method for a heat exchanger of a chiller.

Historical running data relating to a heat exchanger of a chiller is retrieved (step S31), comprising outlet and inlet temperatures of output matter, outlet and inlet temperatures of cooling matter, load current of the chiller, load setting temperature of the chiller, and others. An outlet temperature prediction model for the output matter of the chiller is created according to the historical running data (the process is described in FIG. 3) and outlet temperature of the output matter of the chiller is predicted using the outlet temperature prediction model (step S32).

The invention utilizes statistics regression methods to create prediction models with respect to outlet temperature of output matter of a chiller. Variables affecting outlet temperature of output matter of a chiller can be included in statistics regression analysis, such as PLS, PCR, and others, to obtain an accurately constructed model for accurate estimation of outlet temperature.

Next, real-time running data relating to a chiller is retrieved to obtain performance indexes (KPI) for condition monitoring of a chiller (step S33). With respect to data analysis using a variance analysis method, based on different outlet temperatures of output matter of a chiller, outlet temperature of real output matter of a chiller, inlet of output matter of a chiller, and load current can be differently grouped. Alternatively, KPI defined by different outlet temperature of output matter of a chiller is analyzed and, therefore, identically grouped. The described analysis discloses KPI of the invention can be applied to solve the problem that monitor indexes change following the change of load settings of a chiller and the external environment.

Next, an applicable monitor strategy and statistical model are selected according to a failure mode of a chiller to implement residue-based monitoring (step S34). The invention applies SPC methods to monitor slowly or rapidly changed failure modes, implement condition monitoring to slowly changed failure modes using exponential weighted moving average (EWMA) control charts. The health condition of the chiller is determined according to SPC monitoring results (step S35).

An example for device condition monitoring of the invention is described. A plurality of normal running data relating to a device for a month is utilized and analyzed. Each running data comprises outlet and inlet temperature of output matter of a chiller, outlet and inlet temperature of cooling matter, load current of a chiller, and load setting temperature of a chiller.

SPC strategies of the invention are illustrated according to failure modes generated by slowly changed device conditions. The illustration uses EWMA control charts to analyze the failure modes generated by slowly changed device conditions, in which the moving range for a EWMA control chart generally equals 3 and the value of a weighting factor therefor equals 0.3.

The generation of type I false alarms is controlled using COP, described as follows.

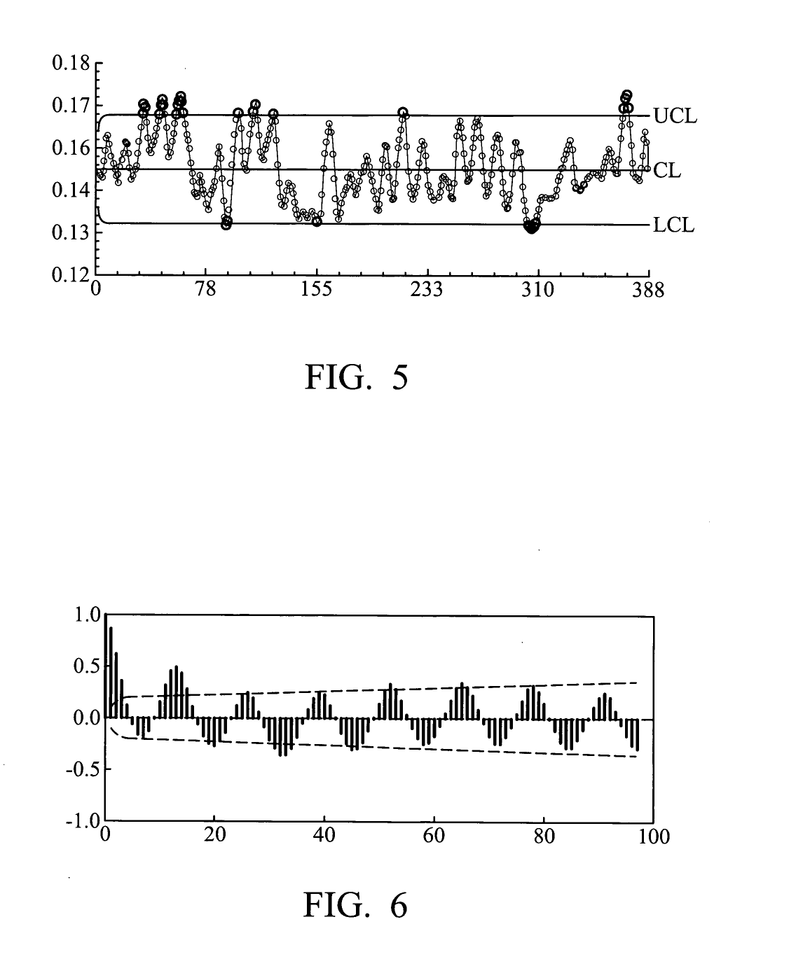

COP is first calculated. A EWMA control chart is generated to control retrieved running data normally. Referring to FIG. 5, the X-axis represents a sampling number, the Y-axis represents a criterion value for EWMA control, CL represents the control limit, UCL represents the upper control limit, and LCL represents the lower control limit. As shown in FIG. 5, a type I false alarm is detected every 10 point intervals, indicating at least one false alarm is generated a day. A false alarm is detected due to the variation of load conditions of a chiller and the external environment, such that control limits thereof should be changed following the variation of load conditions of a chiller and the external environment but monitored using control limits with fixed measurement. COP calculation results indicate whether running data comprises cyclic autocorrelation features. Referring to FIG. 6, in which the X-axis represents lag time and the Y-axis represents autocorrelation criterion values, COP control limits should also represent cyclical variation, and therefore, monitoring implemented using control limits with fixed measurement is unfeasible.

Next, trend control is implemented according to running measurements, such as temperature and load current, to generate type I false alarms, described as follows.

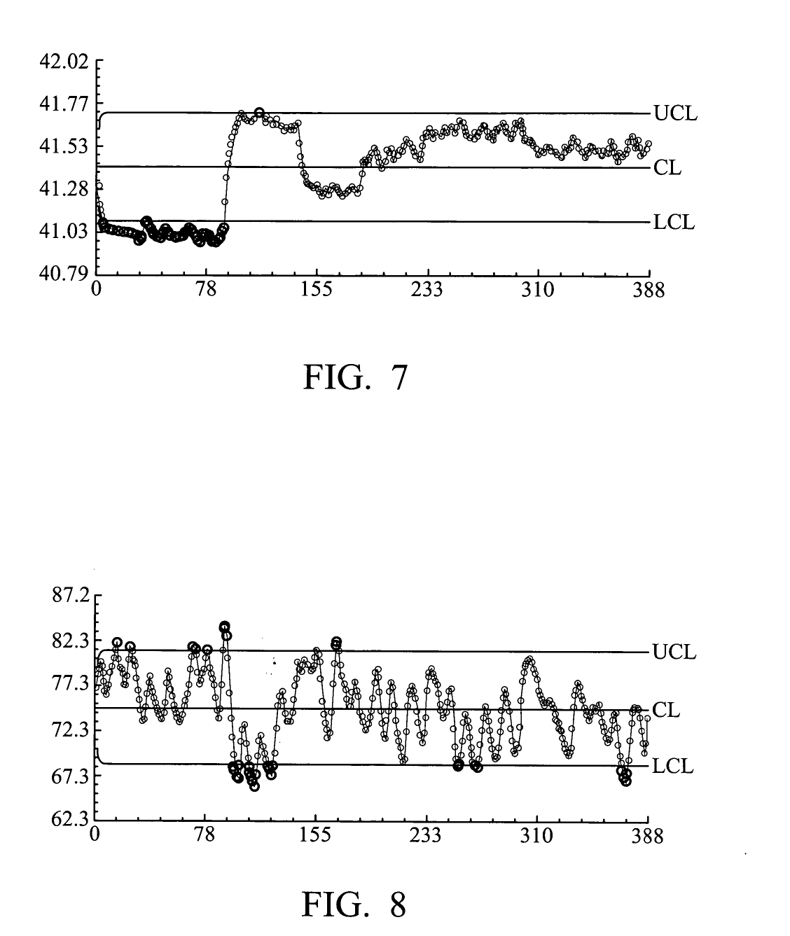

With respect to outlet temperature of output matter of a chiller, a EWMA control chart is generated. Referring to FIG. 7, in which the X-axis represents sampling numbers and the Y-axis represents criterion values for EWMA control, false alarms are detected repeatedly over a period due to different setting temperatures. Such alarms are detected because the outlet temperature of output matter changes following the variation of load settings of a chiller and the external environment, such that control limits with fixed measurement and only a single strategy are not applicable to the outlet temperature of output matter. With respect to load current of output matter of a chiller, a EWMA control chart therefor is generated. Referring to FIG. 8, in which the X-axis represents sampling numbers and the Y-axis represents criterion values for EWMA control, a type I false alarm may be detected every 10 point intervals, indicating at least one false alarm is generated a day. Such alarms are detected because the load current of a chiller changes following the variation of load settings of a chiller and the external environment, such that control limits with fixed measurement and only a single strategy are not applicable to the load current of a chiller.

A method for reducing the number of type I false alarm of the invention is described as follows.

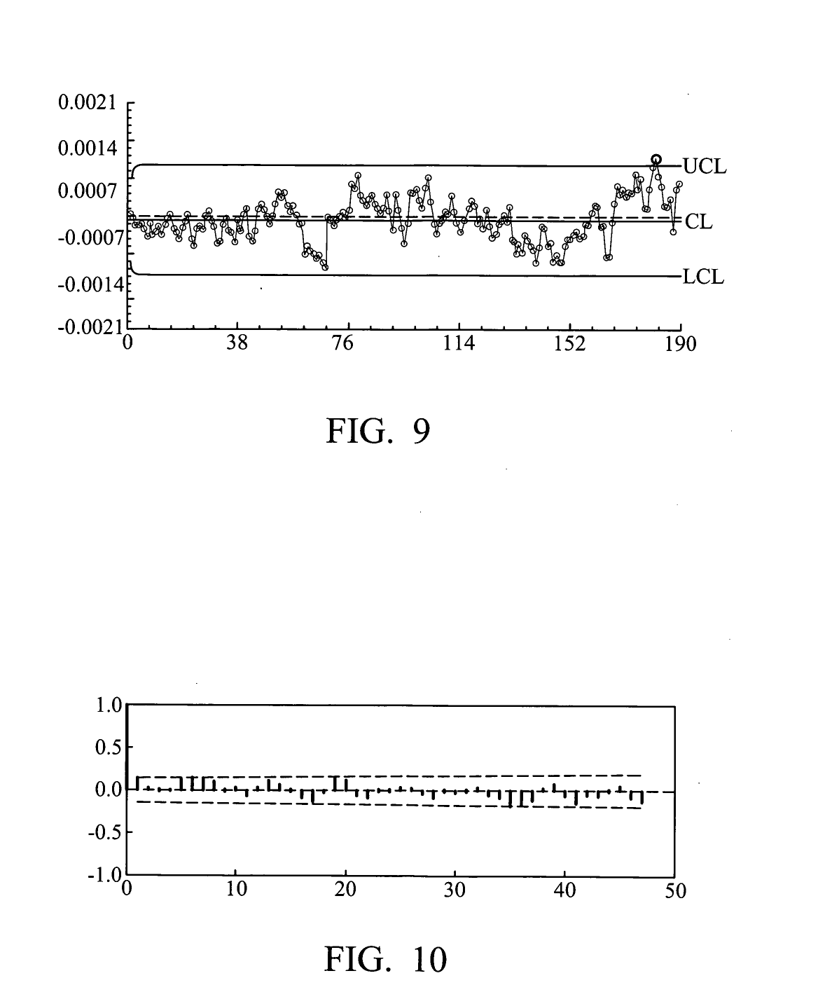

As described, an applicable control strategy is necessary to the health condition monitoring for a chiller. The design for monitoring indexes must remove cyclic autocorrelation features thereof to prevent monitor indexes from changing following variations of setting conditions of chiller load and the external environment, eliminate or reduce the alarm rate for type I false alarms relating to corresponding SPC strategies, and utilize control limits with fixed measurement to implement applicable health condition monitoring for devices. Based on residue-based monitoring strategies of the invention and the illustration for a EWMA control chart relating to normal running data, in which the moving range for the EWMA control chart generally equals 3 and the value of a weighting factor for same equals 0.3, a strategy disclosed in the invention can effectively reduce the number of type I false alarm that a type I false alarm may be detected every 200 point intervals. Referring to FIG. 9, in which the X-axis represents sampling numbers and the Y-axis represents criterion values for EWMA control, 95% of the number of the type I false alarms is decreased. Additionally, cyclic autocorrelation features are controlled within a logical scope. Referring to FIG. 10, in which the X-axis represents delay time and the Y-axis represents autocorrelation values, although a minority of points corresponding to delay time are located above the control limit, the points can be further extracted using an advanced residual mode.

The invention utilizes a statistics regression model (PLS, for example) to accurately estimate a regression model corresponding to outlet temperature of output matter of a chiller according to outlet and inlet temperatures of output matter, outlet and inlet temperatures of cooling matter, load current of a chiller, load setting temperature of the chiller, and other control variables considering historical data, construct predicted residue-based key performance indexes, and solves the problem of COP changes due to the variation of load conditions of a chiller and the external environment.

In this disclosure, a heat exchanger of a chiller is illustrated as an example but is not intend to be limiting. Any monitoring device can be applied to the monitoring method of the invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for calculating key performance indexes relating to a heat exchanger of a chiller, comprising:
defining running indexes for the heat exchanger of the chiller;
obtaining an outlet temperature of output matter of the heat exchanger according to the running indexes, at least comprising load temperature, load current, inlet temperature of cooling matter, outlet temperature of the cooling matter, and inlet temperature of the output matter;
obtaining a performance index according to the inlet and outlet temperatures of the output matter and the load current of the heat exchanger;
obtaining a predicted performance index according to the inlet temperature of the output matter, a predicted outlet temperature of the output matter, and the load current;
obtaining a real performance index according to the inlet temperature of the output matter, real outlet temperature of output matter, and the load current; and
obtaining a key performance index according to the predicted and real performance indexes.

2. The method for calculating key performance indexes as claimed in claim 1, wherein the performance index value is a ratio of the outlet and inlet temperatures of the output matter to the load current value.

3. A real-time condition monitoring method for a heat exchanger of a chiller, comprising:
retrieving historical running data relating to a heat exchanger of a chiller
creating an outlet temperature prediction model for output matter of the heat exchanger according to the historical running data;
predicting an outlet temperature of the output matter of the heat exchanger using the outlet temperature prediction model and obtaining a predicted performance index according to the outlet temperature;
retrieving real-time running data relating to the heat exchanger, obtaining a real performance index relating to the heat exchanger according to the real-time running data, and obtaining a key performance index relating to the heat exchanger according to the predicted and real performance indexes;
monitoring the heat exchanger according to the key performance index using statistical methods; and
determining running conditions relating to the heat exchanger according to monitoring results.

4. The real-time condition monitoring method as claimed in claim 3, wherein model creation further comprises:
determining whether the historical running data is retrieved with the heat exchanger running normally;
if so, creating the outlet temperature prediction model with respect to the output matter of the heat exchanger running normally using statistical methods; and
if not, removing the historical running data retrieved abnormally.

5. The real-time condition monitoring method as claimed in claim 3, wherein obtaining key performance index further comprises:
defining running indexes for the heat exchanger of the chiller;
obtaining the outlet temperature of the output matter of the heat exchanger according to the running indexes, at least comprising a load temperature, a load current, an inlet temperature of cooling matter, an outlet temperature of cooling matter, and an inlet temperature of the output matter;
obtaining the performance index according to the inlet and outlet temperatures of the output matter and load current of the heat exchanger;
obtaining the predicted performance index according to the inlet and a predicted outlet temperatures of the output matter and the load current;
obtaining the real performance index according to the inlet and a real outlet temperature of the output matter and the load current; and
obtaining the key performance index according to the predicted and real performance indexes.

6. The real-time condition monitoring method as claimed in claim 5, wherein the performance index value is a ratio of a value of the outlet and inlet temperatures of the output matter to the load current value.

7. A storage medium for storing a computer program providing a real-time condition monitoring method for a heat exchanger of a chiller, comprising using a computer to perform the steps of:
retrieving historical running data relating to a heat exchanger of a chiller
creating an outlet temperature prediction model for output matter of the heat exchanger according to the historical running data;
predicting an outlet temperature of the output matter of the heat exchanger using the outlet temperature prediction model and obtaining a predicted performance index according to the outlet temperature;
retrieving real-time running data relating to the heat exchanger, obtaining a real performance index relating to the heat exchanger according to the real-time running data, and obtaining a key performance index relating to the heat exchanger according to the predicted and real performance indexes;
monitoring the heat exchanger according to the key performance index using statistical methods; and
determining running conditions relating to the heat exchanger according to monitoring results.

8. The storage medium as claimed in claim 7, wherein model creation further comprises:
determining whether the historical running data is retrieved as the heat exchanger runs normally;
if the historical running data is retrieved as the heat exchanger runs normally, creating the outlet temperature prediction model with respect to the output matter of the heat exchanger running normally using statistical methods; and
removing the historical running data with retrieved as the heat exchanger runs abnormally.

9. The storage medium as claimed in claim 7, wherein obtaining key performance index further comprises:
defining running indexes for the heat exchanger of the chiller;
obtaining the outlet temperature of the output matter of the heat exchanger according to the running indexes, at least comprising a load temperature, a load current, an inlet temperature of cooling matter, an outlet temperature of cooling matter, and an inlet temperature of the output matter;
obtaining the performance index according to the inlet and outlet temperatures of the output matter and load current of the heat exchanger;
obtaining the predicted performance index according to the inlet temperature and a predicted outlet temperature of the output matter and the load current;
obtaining the real performance index according to the inlet temperature and a real outlet temperature of the output matter and the load current; and
obtaining the key performance index according to the predicted and real performance indexes.

10. The storage medium as claimed in claim 9, wherein the performance index value is a ratio of a value of the outlet and inlet temperatures of the output matter to the load current value.
